(19) United States
(12) Patent Application Publication
(10) Pub. No.: US 2010/0197842 A1
(43) Pub. Date: Aug. 5, 2010

(54) RESIN COMPOSITION AND MOLDED BODY OBTAINED BY MOLDING THE SAME

(75) Inventor: Hiroo Kamikawa, Kyoto (JP)

Correspondence Address: FILDES & OUTLAND, P.C., 20916 MACK AVENUE, SUITE 2, GROSSE POINTE WOODS, MI, 48236, US

(73) Assignee: UNITIKA LTD., Hyogo (JP)

(21) Appl. No.: 12/679,492

(22) PCT Filed: Sep. 26, 2008
(86) PCT No.: PCT/JP2008/002675

§ 371 Date: Mar. 23, 2010

(30) Foreign Application Priority Data
Sep. 27, 2007 (JP) 2007-251439

(51) Int. Cl. C08K 5/29

(52) U.S. Cl. 524/195

(57) ABSTRACT

Disclosed is a resin composition excellent in mechanical strength, heat resistance, moist-heat durability and flame retardancy, and low in dependence on petroleum products. The resin composition includes a polylactic acid resin (A), a polycarbonate resin (B), a styrene thermoplastic elastomer (C), a monocarbodiimide compound (D) and a polyfunctional carbodiimide compound (E), wherein the mass ratio (A/B) between the polylactic acid resin (A) and the polycarbonate resin (B) is 25/75 to 90/10.

### TECHNICAL FIELD

The present invention relates to a resin composition and a molded body obtained by molding the same, in particular, a resin composition mainly composed of a polylactic acid resin and a polycarbonate resin and a molded body obtained by molding the same.

### BACKGROUND ART

Recently, from the viewpoint of the environmental preservation, resins using biomass raw materials including polylactic acid resins have been attracting attention. Of biomass-derived resins, polylactic acid resins are among highly heat-resistant resins, can be mass-produced, and hence are low in production cost and high in usefulness. Polylactic acid resins can be produced by using as starting materials plants such as corn and sweet potato, and can contribute to the saving of the exhaustive resources such as petroleum. In the cases of plant-derived resins, the carbon in the plant starting material is originated from the fixation of the carbon in the atmosphere and does not bring the carbon in the ground onto the surface of the Earth, in contrast to petroleum, and hence is free from the problem of the global warming due to the increase of the amount of the carbon dioxide emissions.

However, although polylactic acid resins are highly heat-resistant resins among the biomass-derived resins, the heat resistance of polylactic acid resins is not necessarily sufficient as compared to the general-purpose resins such as polypropylene resin (PP) and acrylonitrile/butadiene/styrene copolymer resin (ABS). Additionally, polylactic acid resins are poor in mechanical properties, in particular, low in impact strength. Yet additionally, polylactic acid resins are also poor, as products produced thereof, in long-term moist-heat durability, are remarkably deteriorated in high-temperature and high-humidity environment, and have a drawback that when polylactic acid resins are used for products such as automobile components and enclosures of home electric appliances in which general-purpose resins are used, the products of polylactic acid resins come to be degraded in performance before the expiration of the service lives required for usual final products of such components and enclosures.

For the purpose of compensating such drawbacks of polylactic acid resins, there have been investigated alloys of polylactic acid resins with other resins, in particular, with aromatic polycarbonate resins high in heat resistance and in impact resistance. As compared to 100% petroleum-derived resins, even such alloy resins have the reduction effect of the environmental load such as the saving of the petroleum resources and the reduction of the amount of the carbon dioxide emissions.

For example, JP-H07-109413A proposes a simple alloy composed of a polylactic acid resin and an aromatic polycarbonate resin. However, only a simple melt-kneading of a polylactic acid and an aromatic polycarbonate hardly attains a uniform compatibilization because of the large melt-viscosity difference between the polylactic acid and the aromatic polycarbonate, and for example, disadvantageously the molten resin is discharged from the nozzle of a kneading extruder in a pulsating manner so as to disturb a stable formation of pellets. Additionally, because the exterior appearance of the resin has a non-pearly luster, when the resin is colored by directly mixing colorants with the resin, haze is conspicuous, the coloration is difficult and thus the applications of such an alloy are restricted.

For the purpose of overcoming the problems involving the compatibility, performances and exterior appearance of the alloy composed of a polylactic acid resin and a polycarbonate resin, the mixing of the following compatibilizers and the impact resistance improvers has been proposed.

In JP2007-056247A, mixing of a polymer compound including an acrylic resin or a styrene resin unit through grafting has been proposed. In JP2005-320409A, mixing of a copolymer obtained by graft polymerizing a vinyl monomer to a rubbery polymer has been proposed.

Either of these proposals attains some improvement effects of mechanical properties, impact resistance, exterior appearance and the like, but no sufficient improvement effects of moist-heat durability. Consequently, it is difficult to use the resin compositions based on these proposals, for automobile components and electric components used under high temperature environments.

Methods of mixing epoxy compounds, oxazoline compounds and carbodiimide compounds with polylactic acid resins have been known as methods for improving the moist-heat durability of polylactic acid resins. For example, JP2002-030208A has proposed a method in which to the terminal carboxyl groups of a polylactic acid, carbodiimide compounds, epoxy compounds and the like are added. JP2005-232225A has proposed a method in which with a crosslinked polylactic acid resin, an epoxy compound, an oxazoline compound and a carbodiimide compound are mixed. JP2006-249152A has proposed a method in which with a polyester resin mainly composed of a polylactic acid, a carbodiimide compound and a phosphite compound are mixed.

The above-described methods in which epoxy compounds, oxazoline compounds and carbodiimide compounds are mixed with polylactic acid resins are also effective to alloys between a polylactic acid resin and a polycarbonate resin, and can improve the moist-heat durability of the alloy concerned. JP2007-056246A has proposed a mixing of an epoxy compound, an oxazoline compound and a carbodiimide compound with an alloy composed of a polylactic acid resin and a polycarbonate resin, to thereby improve the moist-heat durability of the alloy.

Although JP2007-056246A has evaluated the strength retention rate at 60° C. under a high humidity in 200 hours, the moist-heat durability at 65° C. or higher is required for applications, such as automobile applications, in which a more severe moist-heat durability is demanded. Therefore, the resin proposed in JP2007-056246A is insufficient in moist-heat durability.

When resins are used in the electrical applications as components such as enclosure components of laptop personal computers, projectors and copying machines, the resins are also required to be flame retardant. When no halogen-based flame retardants high in environmental load are used, methods in which phosphorus-based flame retardants such as phosphoric acid esters and phosphoric acid salts are mixed are effective for improving the flame retardancy. However, in such cases, disadvantageously the moist-heat durability and the residence stability in molding are degraded.

Flame retardant resin compositions in which a phosphorus-based flame retardant is mixed with an alloy composed of a polylactic acid resin and a polycarbonate resin have been proposed in JP2007-056247A, JP2007-056246A, JP2005-060637A and JP2006-182994A. However, no resin compositions having sufficient performances in the mechanical strength, impact resistance and moist-heat durability have been obtained.

### DISCLOSURE OF THE INVENTION

### Problems to be Solved by the Invention

The present invention solves the above-described problems, and an object of the present invention is to provide a resin composition mainly composed of a polylactic acid resin and a polycarbonate resin, the resin composition being excellent in heat resistance, impact resistance and moist-heat durability in an environment at 65° C. or higher, and being low in the global environmental load. Moreover, another object of the present invention is to provide, for applications requiring flame retardancy and moist-heat durability, a resin composition in which the flame retardancy and the moist-heat durability are compatible with each other.

### Means for Solving the Problems

The present inventor made a diligent study in order to solve the above-described problems, and consequently has reached the present invention by discovering that the above-described objects are achieved by a resin composition including a polylactic acid resin, a polycarbonate resin, a styrene thermoplastic elastomer and a carbodiimide compound, and a composition obtained by mixing a phosphorus-based flame retardant with the above-described resin composition. Specifically, the subject matter of the present invention is as follows.

(1) A resin composition including a polylactic acid resin (A), a polycarbonate resin (B), a styrene thermoplastic elastomer (C), a monocarbodiimide compound (D) and a polyfunctional carbodiimide compound (E), wherein the mass ratio (A/B) between the polylactic acid resin(A) and the polycarbonate resin(B) is 25/75 to 90/10.

(2) The resin composition according to (1), wherein the amount of the styrene thermoplastic elastomer (C) is 3 to 20 parts by mass in relation to 100 parts by mass of the total amount of the polylactic acid resin (A) and the polycarbonate resin (B), the total amount of the monocarbodiimide compound (D) and the polyfunctional carbodiimide compound (E) is 0.5 to 5 parts by mass in relation to 100 parts by mass of the total amount of the polylactic acid resin (A) and the polycarbonate resin (B), and the mass ratio (D/E) between the monocarbodiimide compound (D) and the polyfunctional carbodiimide compound (E) is 10/90 to 90/10.

(3) The resin composition according to (1) or (2), wherein the styrene thermoplastic elastomer (C) is of a hydrogenated type.

(4) The resin composition according to any one of (1) to (3), wherein the styrene thermoplastic elastomer (C) has a functional group.

(5) The resin composition according to any one of (1) to (4), further including a phosphorus-based flame retardant (F).

(6) The resin composition according to any one of (1) to (5), wherein the polylactic acid resin (A) is a crosslinked polylactic acid resin.

(7) A molded body obtained by molding the resin composition according to any one of (1) to (6).

### ADVANTAGES OF THE INVENTION

According to the present invention, a resin composition and a molded body each having excellent mechanical properties, an excellent moist-heat durability, an excellent exterior appearance, and a low dependence on petroleum products. The molded body can be an injection molded body or the like, and can be effectively used, in a manner taking advantage of the above-described properties, in various applications such as mechanical structure components, electric and electronic components, building components, automobile components and daily commodities. The resin composition and the molded body use resins derived from natural products, and hence can contribute to the saving of the exhaustive resources such as petroleum and the reduction of the amount of the carbon dioxide emissions, and thus are extremely valuable in industrial applications.

### BEST MODE FOR CARRYING OUT THE INVENTION

Hereinafter, the present invention is described in detail.

The resin composition of the present invention includes a polylactic acid resin (A), a polycarbonate resin (B), a styrene thermoplastic elastomer (C), a monocarbodiimide compound (D) and a polyfunctional carbodiimide compound (E). When the resin composition is provided with flame retardancy, the resin composition can include a phosphorus-based flame retardant (F).

In the resin composition of the present invention, the mass ratio (A/B) between the polylactic acid resin (A) and the polycarbonate resin (B) is required to be 25/75 to 90/10 and is preferably 40/60 to 70/30. When the proportion of the polylactic acid resin (A) is less than 25% by mass, the proportion of the biomass raw material comes to be small, and the merit viewed from the environmental aspect is diminished. On the other hand, when the proportion of polylactic acid resin (A) exceeds 90% by mass, physical properties such as the heat resistance and the impact resistance are impaired.

Examples of the polylactic acid resin (A) used in the present invention include poly(L-lactic acid), poly(D-lactic acid), and the mixtures or the copolymers of these. Such polylactic acid resins (A) are produced by the known melt polymerization method, or where necessary by further using in combination the solid phase polymerization method.

In the present invention, as long as the properties of the polylactic acid resin (A) are not impaired, a resin composed of the polylactic acid resin and one or more other biodegradable resins may be used as the polylactic acid resin (A). Examples of the other biodegradable resins include aliphatic polyesters, composed of diols and dicarboxylic acids, typified by poly(ethylene succinate), poly(butylene succinate) and poly(butylene succinate-co-butylene adipate); polyhydroxycarboxylic acids such as polyglycolic acid, poly(3-hydroxybutyric acid), poly(3-hydroxyvaleric acid) and poly(3-hydroxycaproic acid); poly(ω-hydroxyalkanoates) typified by poly(ε-caprolactone) and poly(δ-valerolactone); polymers exhibiting biodegradability, in spite of containing aromatic components, such as poly(butylene succinate-co-butylene terephthalate) and poly(butylene adipate-co-butylene terephthalate); polyester amides; polyester carbonates; and polysaccharides such as starch. These components may be used each alone or in combinations of two or more thereof, or may be copolymerized with each other. Alternatively, these components may be simply mixed with the polylactic acid, the main component, or may be copolymerized with the polylactic acid.

In the present invention, the melt flow rate of the polylactic acid resin (A) at 190° C. under a load of 21.2 N is preferably 0.1 to 50 g/10 min, more preferably 0.2 to 40 g/10 min and furthermore preferably 0.5 to 30 g/10 min. When the melt flow rate exceeds 50 g/10 min, the melt viscosity is too low and consequently the mechanical properties and the moist-heat durability of the molded body may be poor. On the other hand, when the melt flow rate is less than 0.1 g/10 min, the load at the time of molding processing is too high and consequently the operability may be degraded.

In the present invention, when a crosslinked polylactic acid resin is used as the polylactic acid resin (A), the heat resistance and the operability at the time of melt kneading can be improved. The crosslinked polylactic acid resin is obtained by introducing a crosslinked structure into the polylactic acid resin. The crosslinking form is not particularly limited, and may be a direct mutual crosslinking of the polylactic acid resin molecules, an indirect mutual crosslinking, through a crosslinking aid, of the polylactic acid resin molecules, or a mixture of these direct and indirect crosslinking of the polylactic acid resin molecules.

As the method for introducing a crosslinked structure into the polylactic acid resin, known methods such as electron beam irradiation and the use of multifunctional compounds such as polyvalent isocyanate compounds can be applied. However, from the viewpoint of the crosslinking efficiency, the radical crosslinking by use of a peroxide is preferable.

Specific examples of the peroxide used for that purpose include: benzoyl peroxide, bis(butylperoxy)trimethylcyclohexane, bis(butylperoxy)cyclododecane, butyl bis(butylperoxy)valerate, dicumylperoxide, butyl peroxybenzoate, dibutyl peroxide, bis(butylperoxy)diisopropylbenzene, dimethyldi(butylperoxy)hexane, dimethyldi(butylperoxy)hexyne and butylperoxycumene. The mixing amount of the peroxide is preferably 0.1 to 20 parts by mass and more preferably 0.1 to 10 parts by mass in relation to 100 parts by mass of the polylactic acid resin. Although the peroxide can be used in a mixing amount exceeding 20 parts by mass, such a mixing amount results in the saturation of the effect of the peroxide, and additionally is not economical. It is to be noted that such a peroxide is consumed by decomposition when being mixed with the resin, and hence the peroxide may be absent in the obtained resin composition even if the peroxide is used at the time of mixing.

For the purpose of increasing the crosslinking efficiency, it is preferable to use a crosslinking aid along with a peroxide. Examples of the usable crosslinking aid include the following multifunctional monomers: divinylbenzene, diallylbenzene, divinylnaphthalene, divinylphenyl, divinylcarbazole, divinylpyridine and nuclear substituted compounds and closely-related homologs of these; multifunctional acrylate compounds such as ethylene glycol diacrylate, butylene glycol diacrylate, triethylene glycol diacrylate, 1,6-hexanediol diacrylate and tetramethylolmethane tetraacrylate; multifunctional methacrylate compounds such as ethylene glycol dimethacrylate, butylene glycol dimethacrylate, triethylene glycol dimethacrylate, tetraethylene glycol dimethacrylate, 1,6-hexanediol dimethacrylate, 1,9-nonanediol dimethacrylate, 1,10-decanediol dimethacrylate, trimethylolpropane trimethacrylate and tetramethylolmethane tetramethacrylate; polyvinyl esters of aliphatic and aromatic polycarboxylic acids such as divinyl phthalate, diallyl phthalate, diallyl maleate and bisacryloyloxyethyl terephthalate; polyallyl esters, polyacryloyloxyalkyl esters and polymethacryloyloxyalkyl esters; polyvinyl ethers and polyallyl ethers of aliphatic and aromatic polyhydric alcohols such as diethylene glycol divinyl ether, hydroquinone divinyl ether and bisphenol-A diallyl ether; allyl esters of cyanuric acid and isocyanuric acid such as triallyl cyanurate and triallyl isocyanurate; triallyl phosphate and trisacryloxyethyl phosphate; maleimide compounds such as N-phenyl maleimide and N,N′-m-phenylene bismaleimide; and compounds having two or more triple bonds such as dipropargyl phthalate and dipropargyl maleate.

Preferable among these crosslinking aids are (meth)acrylic acid ester compounds, from the viewpoint of the crosslinking reactivity. Through the intermediary of this component, the polylactic acid resin component is crosslinked, and improved in mechanical strength, heat resistance and dimensional stability. Preferable as the (meth)acrylic acid ester compound are the compounds each having two or more (meth)acryl groups in the molecule thereof or having one or more (meth)acryl groups and one or more glycidyl groups or vinyl groups in the molecule thereof because such compounds are high in the reactivity with biodegradable resins and hence small in the amount of the residual monomers, are relatively less toxic and scarcely cause the coloration of the resin. Specific examples of such compounds include glycidyl methacrylate, glycidyl acrylate, glycerol dimethacrylate, trimethylolpropane trimethacrylate, trimethylolpropane triacrylate, allyloxypolyethylene glycol monoacrylate, allyloxypolyethylene glycol monomethacrylate, polyethylene glycol dimethacrylate, polyethylene glycol diacrylate, polypropylene glycol dimethacrylate, polypropylene glycol diacrylate and polytetramethylene glycol dimethacrylate. Additionally, the specific examples may also include the copolymers of alkylene glycols which are different in the type of the alkylene group from each other, namely, the copolymers obtained by partially replacing the alkylene glycol portions of the above-described compounds with one or more different types of alkylene groups. Yet additionally, the specific examples also include butanediol methacrylate and butanediol acrylate.

When a (meth)acrylic acid ester compound is mixed as the crosslinking aid, the amount of the (meth)acrylic acid ester compound is appropriately 0.01 to 20 parts by mass, preferably 0.05 to 10 parts by mass and more preferably 0.1 to 5 parts by mass, in relation to 100 parts by mass of the polylactic acid resin. As long as the operability is not particularly impaired, the crosslinking aid can also be used in an amount exceeding 20 parts by mass.

Examples of the method with which a peroxide as the crosslinking agent and a (meth)acrylic acid ester compound as the crosslinking aid are mixed with the polylactic acid resin may include a method in which melt-kneading is performed with a common extruder. In the sense that the kneaded conditions are made satisfactory, it is preferable to use a double screw extruder. The kneading temperature preferably falls within a range from (the melting point of the polylactic acid resin +5° C.) to (the melting point of the polylactic acid resin +100° C.). The kneading time is preferably 20 seconds to 30 minutes. When the kneading temperature is lower than the above-described temperature range or the kneading time is shorter than the above-described time range, the kneading or the reaction is insufficient. On the other hand, when the kneading temperature or the kneading time is respectively higher or longer than the corresponding range, the decomposition or the coloration of the resin may occur. In the mixing, when the (meth)acrylic acid ester compound and the peroxide are solid, the (meth)acrylic acid ester compound and the peroxide are preferably fed with dry blending or a powder feeder. When these are liquid, these are preferably directly injected with a pressure pump into the barrel of the extruder.

Example of a preferable mixing method when the (meth)acrylic acid ester compound and the peroxide are used in combination include a method in which the (meth)acrylic acid ester compound and/or the peroxide is dissolved or dispersed in a medium, and the resulting solution or dispersion is injected into the kneader. In this way, the operability can be remarkably improved. For example, while the polylactic acid resin component and the peroxide are being melt-kneaded, a solution or dispersion of the (meth)acrylic acid ester compound is injected, or while the polylactic acid resin is being melt-kneaded, a solution or dispersion of the (meth)acrylic acid ester compound and the peroxide is injected, and subsequently these ingredients can be melt kneaded.

As the medium in which the (meth)acrylic acid ester compound and/or the peroxide is dissolved or dispersed, a common medium is used and such medium is not particularly limited. Among others, preferable as the medium is a plasticizer excellent in the compatibility with the polylactic acid resin. Examples of such a plasticizer include one or more plasticizers selected from aliphatic polycarboxylic acid ester derivatives, aliphatic polyhydric alcohol ester derivatives, aliphatic oxyester derivatives, aliphatic polyether derivatives, aliphatic polyether polycarboxylic acid ester derivatives and the like. Specific examples of the plasticizer compound include glycerin diacetomonolaurate, glycerin diacetomonocaprate, dimethyl adipate, dibutyl adipate, triethylene glycol diacetate, methyl acetylrecinolate, acetyl tributylcitrate, polyethylene glycol and dibutyl diglycol succinate. The used amount of the plasticizer is preferably 30 parts by mass or less, and more preferably 0.1 to 20 parts by mass in relation to 100 parts by mass of the polylactic acid resin. When the reactivity of the crosslinking agent such as a peroxide is low, the use of the plasticizer may be omitted. However, when the reactivity of the crosslinking agent is high, the plasticizer is preferably used in an amount of 0.1 part by mass or more. It is to be noted that a plasticizer is sometimes evaporated at the time of mixing with the resin, and hence no plasticizer may remain in the obtained resin composition even if the plasticizer is used at the time of production.

Next, the polycarbonate resin (B) is described. The polycarbonate resin (B) is composed of a repeating unit formed with a bisphenol residue and a carbonate residue.

Examples of the bisphenols as starting materials include 2,2-bis(4-hydroxyphenyl)propane (bisphenol-A), 2,2-bis(3,5-dibromo-4-hydroxyphenyl)propane, 2,2-bis(3,5-dimethyl-4-hydroxyphenyl)propane, 1,1-bis(4-hydroxyphenyl)cyclohexane, 1,1-bis(3,5-dimethyl-4-hydroxyphenyl)cyclohexane, 1,1-bis(4-hydroxyphenyl)decane, 1,4-bis(4-hydroxyphenyl)propane, 1,1-bis(4-hydroxyphenyl)cyclododecane, 4,4′-dihydroxydiphenyl ether, 4,4′-dithiodiphenol, 4,4′-dihydroxy-3,3′-dichlorodiphenyl ether and 4,4′-dihydroxy-2,5-dihydroxydiphenyl ether. In addition to these, the diphenols described in U.S. Pat. Nos. 2,999,835, 3,028,365, 3,334,154 and 4,131,575 can be used. These may be used each alone or as mixtures of two or more thereof.

Examples of the precursor for introducing a carbonate residue unit include phosgene and diphenyl carbonate.

The intrinsic viscosity of the polycarbonate resin (B) used in the resin composition of the present invention preferably falls within a range from 0.35 to 0.64. When the intrinsic viscosity exceeds 0.64, the melt viscosity of the resin composition comes to be high, and kneading extrusion molding, injection molding and the like may be difficult. On the other hand, when the intrinsic viscosity is less than 0.35, the impact strength of the obtained molded product may be insufficient.

In the present invention, by using the styrene thermoplastic elastomer (C), the impact resistance of the resin composition improves, and the moist-heat durability of the resin composition improves compared with a case in which other impact resistance improvers are used.

The styrene thermoplastic elastomer (C) used in the present invention is a block copolymer being composed of polystyrene, polybutadiene, polyisoprene, polyolefin and the like, and having a polystyrene phase at both terminals and having in the intermediate phase polybutadiene, polyisoprene and polyolefin (ethylene/butylene or ethylene/propylene). By selectively hydrogenating the unsaturated double bonds in the polybutadiene portions of the intermediate phase of the styrene-butadiene-styrene block copolymer, not only the butadiene structure but the butylene structure and the ethylene structure can be introduced into the intermediate phase. Similarly, by selectively hydrogenating the unsaturated double bonds in the isoprene portions of the styrene-polyisoprene-styrene block copolymer, the propylene structure and ethylene structure can be introduced into the intermediate phase. In the present invention, the above-described styrene thermoplastic elastomer or the materials having the analogous structures can be used without any particular limitations. However, from the viewpoint of the heat resistance and the weather resistance, hydrogenated styrene thermoplastic elastomers which have as smaller number of unsaturated double bonds as possible are preferable.

Examples of the specific trade names of such hydrogenated styrene thermoplastic elastomer include “Toughtec” H Series manufactured by Asahi Kasei Chemicals Corp.

From the viewpoint of the compatibility with the polylactic acid resin/polycarbonate resin, it is preferable to use a styrene thermoplastic elastomer into which functional groups such as a carboxylic acid group, an amino group and an epoxy group are introduced. Examples of specific commercial products of the styrene thermoplastic elastomer into which functional groups are introduced include “Toughtec” M series and N series manufactured by Asahi Kasei Chemicals Corp. and “Epofriend” manufactured by Daicel Chemical Industries, Ltd.

The mixing amount of the styrene thermoplastic elastomer (C) in the resin composition of the present invention is preferably 3 to 20 parts by mass and more preferably 5 to 15 parts by mass in relation to 100 parts by mass of the total amount of the polylactic acid resin (A) and the polycarbonate resin (B). When the mixing amount is less than 3 parts by mass, almost no improvement effect of the impact resistance is obtained, and when the mixing amount exceeds 20 parts by mass, the heat resistance may be degraded.

In the present invention, for the purpose of improving the moist-heat durability the monocarbodiimide compound (D) and the polyfunctional carbodiimide compound (E) are mixed with the resin composition in combination.

The monocarbodiimide compound (D) is a compound which has in the molecule thereof a carbodiimide group represented by (—N═C═N—). The polyfunctional carbodiimide compound (E) is a compound which has in the molecule thereof two or more carbodiimide groups represented by (—N═C═N—). By mixing the combination of the monocarbodiimide compound (D) and the polyfunctional carbodiimide compound (E) with the resin composition, it is possible to impart an excellent moist-heat durability to the resin composition in a synergetic manner as compared to the case where the monocarbodiimide compound (D) and the polyfunctional carbodiimide compound (E) are mixed with the resin composition each alone. The reasons for this are not clear, but it can be inferred as follows.

The carbodiimide group reacts with the terminal carboxylic acid group of the polylactic acid molecule, and hence has an effect to prevent the promotion effect of the hydrolysis of the molecule due to the terminal carboxylic acid group. The polyfunctional carbodiimide compound has two or more carbodiimide groups, and hence reacts with the two or more polylactic acid molecules which have been decomposed to have shorter lengths; in this way, the polyfunctional carbodiimide compound has a chain extension effect to increase the molecular weight of the polylactic acid molecules as a whole. However, the polyfunctional carbodiimide compound has a drawback that the polyfunctional carbodiimide compound is larger in molecular weight, worse in dispersibility and worse in reactivity as compared to the monocarbodiimide compound. Further, the polyfunctional carbodiimide compound has another drawback that when one of the carbodiimide groups thereof has reacted with and has been bonded to a polylactic acid molecule, the polyfunctional carbodiimide compound is still more constrained in the movement thereof and hence the remaining carbodiimide groups of the polyfunctional carbodiimide compound scarcely tend to react with the terminal carboxylic acid groups of the other polylactic acid molecules. On the other hand, the monocarbodiimide compound is smaller in molecular weight, hence easily moves about, consequently is excellent in dispersibility, and free from such a problem that the carbodiimide group remains after the reaction. However, the monocarbodiimide compound has no chain extension effect of the polylactic acid molecule. It is inferred that the use of the monocarbodiimide compound and the polyfunctional carbodiimide compound in combination results in mutual compensation of the drawbacks of the counterpart.

Examples of the monocarbodiimide compound (D) used in the present invention include: diphenylcarbodiimide, di-cyclohexylcarbodiimide, di-2,6-dimethylphenylcarbodiimide, diisopropylcarbodiimide, dioctyldecylcarbodiimide, di-o-toluoylcarbodiimide, di-p-toluoylcarbodiimide, di-p-nitrophenylcarbodiimide, di-p-aminophenylcarbodiimide, di-p-hydroxyphenylcarbodiimide, di-p-chlorophenylcarbodiimide, di-o-chlorophenylcarbodiimide, di-3,4-dichlorophenylcarbodiimide, di-2,5-dichlorophenylcarbodiimide, p-phenylene-bis-o-toluoylcarbodiimide, p-phenylene-bis-dicyclohexylcarbodiimide, p-phenylene-bis-di-p-chlorophenylcarbodiimide, 2,6,2′,6′-tetraisopropyldiphenylcarbodiimide, hexamethylene-bis-cyclohexylcarbodiimide, ethylene-bis-diphenylcarbodiimide, ethylene-bis-di-cyclohexylcarbodiimide, N,N′-di-o-toluoylcarbodiimide, N,N′-diphenylcarbodiimide, N,N′-dioctyldecylcarbodiimide, N,N′-di-2,6-dimethylphenylcarbodiimide, N-toluoyl-N′-cyclohexylcarbodiimide, N,N′-di-2,6-diisopropylphenylcarbodiimide, N,N′-di-2,6-di-tert-butylphenylcarbodiimide, N-toluoyl-N′-phenylcarbodiimide, N,N′-di-p-nitrophenylcarbodiimide, N,N′-di-p-aminophenylcarbodiimide, N,N′-di-p-hydroxyphenylcarbodiimide, N,N′-di-cyclohexylcarbodiimide, N,N′-di-p-toluoylcarbodiimide, N,N′-benzylcarbodiimide, N-octadecyl-N′-phenylcarbodiimide, N-benzyl-N′-phenylcarbodiimide, N-octadecyl-N′-tolylcarbodiimide, N-cyclohexyl-N′-tolylcarbodiimide, N-phenyl-N′-tolylcarbodiimide, N-benzyl-N′-tolylcarbodiimide, N,N′-di-o-ethylphenylcarbodiimide, N,N′-di-p-ethylphenylcarbodiimide, N,N′-di-o-isopropylphenylcarbodiimide, N,N′-di-p-isopropylphenylcarbodiimide, N,N′-di-o-isobutylphenylcarbodiimide, N,N′-di-p-isobutylphenylcarbodiimide, N,N′-di-2,6-diethylphenylcarbodiimide, N,N′-di-2-ethyl-6-isopropylphenylcarbodiimide, N,N′-di-2-isobutyl-6-isopropylphenylcarbodiimide, N,N′-di-2,4,6-trimethylphenylcarbodiimide, N,N′-di-2,4,6-triisopropylphenylcarbodiimide and N,N′-di-2,4,6-triisobutylphenylcarbodiimide. In particular, examples of the monocarbodiimide compound having a high imparting effect of moist-heat durability include N,N′-di-2,6-diisopropylphenylcarbodiimide.

Examples of the polyfunctional carbodiimide compound (E) used in the present invention include: polyfunctional carbodiimide such as poly(1,6-hexamethylenecarbodiimide), poly(4,4′-methylenebiscyclohexylcarbodiimide), poly(1,3-cyclohexylenecarbodiimide), poly(1,4-cyclohexylenecarbodiimide), poly(4,4′-diphenylmethanecarbodiimide), poly(3,3′-dimethyl-4,4′-diphenylmethanecarbodiimide), poly(naphthylenecarbodiimide), poly(p-phenylenecarbodiimide), poly(m-phenylenecarbodiimide), poly(tolylcarbodiimide), poly(diisopropylcarbodiimide), poly(methyl-diisopropylphenylenecarbodiimide), poly(triethylphenylenecarbodiimide) and poly(triisopropylphenylenecarbodiimide).

The carbodiimide compounds can be produced by known methods; for example, the carbodiimide compounds can be produced by a carbodiimide reaction which uses a diisocyanate compound as a starting material and is accompanied by a carbon dioxide elimination reaction. It is to be noted that the isocyanate group may remain at the terminals.

The total of the mixing amount of the monocarbodiimide compound (D) and the mixing amount of the polyfunctional carbodiimide compound (E) in the resin composition of the present invention is preferably 0.5 to 5 parts by mass and particularly preferably 1 to 3 parts by mass in relation to 100 parts by mass of the total amount of the polylactic acid resin (A) and the polycarbonate resin (B). When the total mixing amount is less than 0.1 part by mass, the moist-heat durability does not improve. On the other hand, when the total mixing amount exceeds 5 parts by mass, the heat resistance may be degraded.

The mass ratio (D/E) between the monocarbodiimide compound (D) and the polyfunctional carbodiimide compound (E) is preferably 10/90 to 90/10 and more preferably 30/70 to 70/30. When the mass ratio (D/E) falls outside the range from 10/90 to 90/10, the moist-heat durability does not improve.

The resin composition of the present invention can include the phosphorus-based flame retardant (F). Examples of the phosphorus-based flame retardant (F) usable in the present invention include organic phosphorus compounds, phosphorus as an elemental substance and inorganic phosphorus compounds.

Examples of the organic phosphorus compounds include monomeric organic phosphorus compounds and polymeric organic phosphorus compounds.

Examples of the monomeric organic phosphorus compounds include organic phosphoric acid salts, organic phosphinic acid salts, organic phosphoric acid salts, phosphoric acid esters, phosphorous acid esters, phosphine oxide, hypophosphorous acid esters optionally substituted with an alkyl group and/or an aryl group (for example, 9,10-dihydro-9-oxa-10-phosphaphenanthrene-10-oxide), phosphonocarboxylic acid esters, nitrogen-containing phosphoric acid esters and ammonium salts and amine-containing compound salts of aliphatic acid phosphates.

Examples of the above-described phosphoric acid esters include aliphatic phosphates, aromatic phosphates (such as triphenyl phosphate) and aliphatic-aromatic phosphates.

Examples of the above-described phosphorous acid esters may include aromatic phosphites, aliphatic phosphites and aliphatic-aromatic phosphites.

On the other hand, examples of the polymeric organic phosphorus compound may include condensation products of the above-described monomeric organic phosphorus compounds, phosphoric acid esters of hydroxyl group-containing polymers (such as a phenolic resin), polyphosphinicocarboxylic acid esters, polyphosphoric acid amides and phosphazene compounds.

Examples of the condensation products of the monomeric organic phosphorus compounds may include resorcinol phosphates, hydroquinone phosphates, biphenol phosphates and bisphenol phosphates.

Specific examples of the phosphorus elemental substance usable as the phosphorus-based flame retardant (F) may include red phosphorus.

Examples of the inorganic phosphorus compounds usable as the phosphorus-based flame retardant (F) may include polyphosphoric acid salts, phosphoric acid salts and surface-treated products of red phosphorus. Examples of the phosphoric acid of the phosphoric acid salts may include orthophosphoric acid, phosphorous acid, polyphosphoric acid and polyphosphorous acids (such as metaphosphorous acid and pyrophosphorous acid). Examples of the slats of the phosphoric acid salts may include alkali metal salts (such as lithium slats, sodium salts and potassium salts), alkali earth metal salts (such as magnesium salts and calcium salts), aluminum slats, ammonium salts and amine slats.

Examples of the above-described organic phosphorus compounds, phosphorus elemental substances and inorganic phosphorus compounds also include metal salts and amine-containing compound slats of organic phosphoric acids and inorganic phosphoric acids. The organic phosphoric acids or inorganic phosphoric acids may include an alkyl group and/or an aryl group as substituted therein. As the phosphorus-based flame retardant, the above-described compounds can be used each alone or in combinations of two or more thereof.

Particularly preferable among the above-described phosphorus-based flame retardants are aromatic condensed phosphates and phosphoric acid salts from the viewpoint of the heat resistance, flame retardancy and moist-heat durability. Examples of the commercially available aromatic condensed phosphates include PX-200, PX-201 and PX-202 manufactured by Daihachi Chemical Industry Co., Ltd. Examples of the commercially available phosphoric acid salts include ammonium polyphosphate P422 and AP423 manufactured by Clariant (Japan) K.K.

In the resin composition of the present invention, as the flame retardant other than the phosphorus-based flame retardant (F), one or more flame retardants selected from hydrated metal compounds (aluminum hydroxide, magnesium hydroxide), N-containing compounds (melamine compounds and guanidine compounds), and inorganic compounds (boric acid salts, Mo compounds) may also be used in combination with the phosphorus-based flame retardant (F). As the drip-preventing agent, a fluororesin may also be used.

The addition amount of all the flame retardants used in the resin composition of the present invention may be determined according to the flame retardant performance required depending on the applications, and is preferably 30 parts by mass or less in relation to 100 parts by mass of the resin composition. When the addition amount exceeds 30 parts by mass, there may be a case in which the mechanical strength of the resin degrades.

For the purpose of providing the resin composition of the present invention with flame retardancy, the flame retardancy for a molded product of 1.6 mm ( 1/16 inch) in thickness is preferably such that the UL specified flame retardancy thereof is of the performance of V-2, V-1, V-0 or 5V. Additionally, for the purpose of making the resin composition usable for laptop personal computers, the resin composition is preferably provided with the performance of V-1, V-0 or 5V.

In the present invention, the method for producing the resin composition by mixing the starting materials is not particularly limited, and is only required to provide the resin composition with a condition in which the individual ingredients are uniformly dispersed. Examples of such a method include a method in which the polylactic acid resin (A), the polycarbonate resin (B), the styrene thermoplastic elastomer (C), the carbodiimide compounds (D) and (E), the phosphorus-based flame retardant (F) and other additives are uniformly blended with a tumbler or a Henschel mixer, and then melt kneaded to form pellets. Alternatively, for example, there can be used another method in which these ingredients are mixed in a solution and then the solvent is removed.

In the present invention, a thermoplastic resin (G) other than the resins included in the polylactic acid resin (A) component, the polycarbonate resin (B) component and the styrene thermoplastic elastomer (C) component may also be mixed. Specific examples of the thermoplastic resin (G) include a polyester resin, a phenoxy resin, a cellulose ester resin, a polyamide resin, a polyether imide resin, a styrene resin, a silicone compound-containing core-shell rubber, an ionomer resin, a polyphenylene ether resin, a polyphenyl sulfide resin and a phenolic resin. Among these, particularly preferably used are the polyester resin, the polyamide resin, the styrene resin and the silicone compound-containing core-shell rubber.

The mixing amount of the thermoplastic resin (G) is preferably 0.5 to 100 parts by mass and more preferably 1 to 50 parts by mass in relation to 100 parts by mass of the total amount of the polylactic acid resin (A) and the polycarbonate resin (B). The thermoplastic resin (G) is used as one or more of the thermoplastic resin (G) compounds.

In the resin composition of the present invention, for the purpose of improving the mechanical strength and the heat resistance, an inorganic filler such as glass fiber may be included. The mixing amount of the inorganic filler is preferably 1 to 50 parts by mass in relation to 100 parts by mass of the resin composition.

As the glass fiber, any known glass fiber can be used. The glass fiber may be a surface-treated glass fiber for the purpose of enhancing the adhesiveness with the resin. Examples of the method for adding the glass fiber to the resin may include the addition from the hopper in an extruder or the addition with the side feeder in an extruder on the way of kneading. Alternatively, the glass fiber is processed into a master batch, and the master batch may be used at the time of molding as diluted with the base resin.

To the resin composition of the present invention, as long as the properties of the resin composition are not significantly impaired, additives such as a pigment, a heat stabilizer, an antioxidant, an antiweathering agent, a light resistant agent, a plasticizer, a lubricant, a release agent, an antistatic agent, fillers other than the above-described glass fiber and a crystal nucleating agent can be added.

Examples of the heat stabilizer and the antioxidant include hindered phenols, phosphorus compounds, hindered amines, sulfur compounds, copper compounds, alkali metal halides and vitamin E.

Of the fillers that can be added as the fillers other than the above-described glass fiber, examples of the inorganic filler include talc, calcium carbonate, zinc carbonate, wollastonite, silica, alumina, magnesium oxide, calcium silicate, sodium aluminate, calcium aluminate, sodium aluminosilicate, magnesium silicate, glass balloon, carbon black, zinc oxide, antimony trioxide, zeolite, hydrotalcite, metal fiber, metal whisker, ceramic whisker, potassium titanate, boron nitride, graphite and carbon fiber.

Examples of the organic filler include naturally-occurring polymers such as starch, cellulose fine particles, wood powder, bean curd refuse, rice hull and bran; and the modified products of these.

Among the crystal nucleating agents, examples of the inorganic crystal nucleating agents include talc and kaolin, and examples of the organic crystal nucleating agents include sorbitol compounds, benzoic acid and the metal salts of the compounds derived from benzoic acid, metal salts of phosphoric acid esters and rosin compounds.

The method for mixing these with the resin composition of the present invention is not particularly limited.

The resin composition of the present invention can be converted into various molded bodies by the molding methods such as injection molding, blow molding, extrusion molding and inflation molding, and by the molding methods, applied after sheet formation, such as vacuum molding, pneumatic molding and vacuum pneumatic molding. In particular, the injection molding method is preferably adopted. As the injection molding method, in addition to common injection molding methods, gas injection molding, injection press molding and the like may also be adopted. The injection molding conditions suitable for the resin composition of the present invention are varied according to the ratio between the polylactic acid resin and the polycarbonate resin in the resin composition of the present invention. However, for example, the cylinder temperature is appropriately set so as to fall within a range from 180 to 260° C. and preferably within a range from 190 to 250° C., and the die temperature is preferably set at 140° C. or lower. When the molding temperature is too low, the operability tends to be unstable in such a way that short shot occurs in the molded product, and overloading tends to occur. On the other hand, when the molding temperature is too high, the resin composition is decomposed and a problem that the obtained molded body is degraded in strength or colored and other problems tend to occur.

The resin composition of the present invention can be enhanced in heat resistance by promoting the crystallization thereof. Examples of the method for that purpose include a method in which at the time of injection molding, cooling within the die promotes the crystallization. In this case, the cooling is preferably performed for a predetermined period of time by setting the die temperature at a temperature of the crystallization temperature of the resin composition ±20° C. In consideration of the releasability, subsequently the die temperature is further cooled down to a temperature equal to or lower than the glass transition temperature of the resin composition, and then the die may be opened for taking out the molded product. Alternatively, a method in which the crystallization is promoted after molding may also be adopted. Preferable examples of such a method may include a method in which the obtained molded product is again heat treated at a temperature of the crystallization temperature ±20° C. In the case where two or more crystallization temperatures are involved, the same heat treatment as described above may be performed for the respective crystallization temperatures. In the case where two or more glass transition temperatures are involved, the glass transition temperature free from the problems associated with the molding may be selected. When no problems associated with the molding and the performances are caused, the molding may be performed at a temperature set to be other than the above-described die temperature.

Examples of the molded body of the present invention obtained from the resin composition of the present invention include injection molded products, extrusion molded products, blow molded products, films, fibers and sheets. The resin composition of the present invention can be suitably used particularly for the injection molded products, in particular, for thin-wall injection molded products. These molded products can be used in various applications such as electric and electronic components, machine components, optical apparatuses, building components, automobile components and daily commodities. In particular, these molded products can be usefully employed as enclosures for electronic devices. In particular, the resin composition imparted with flame retardancy can be suitably used for the enclosures for laptop personal computers, projectors, copying machines and printers.

### EXAMPLES

Hereinafter, the present invention is described in more detail with the reference to Examples. However, the present invention is not limited to the following Examples.

The evaluation methods of the various properties in the following Examples and Comparative Examples and the various materials used in the following Examples and Comparative Examples are as follows.

1. Evaluation Methods

(1) Melt Flow Rate (MFR)

The melt flow rate was measured according to JIS K-7210 (test condition 4) under the conditions that the temperature was set at 190° C. and the load was set at 21.2 N.

(2) Intrinsic Viscosity (IV)

The intrinsic viscosity was measured by using a phenol/1,1,2,2-tetrachloroethane mixed solvent (mass ratio: 6/4) at a temperature of 20° C.

(3) Heat Resistance (Deflection Temperature Under Load (DTUL))

The deflection temperature under load was measured according to ASTM D-648, by using a specimen (127×12.7×3.2 mm) with a load of 45 MPa. The deflection temperature under load is preferably 70° C. or higher from the practical viewpoint.

(4) Impact Resistance (Izod Impact Strength)

The Izod impact strength was measured according to ASTM D-256, by using a specimen with a notch (V-shaped cut) formed therein. The impact strength is preferably 50 J/m or more from the practical viewpoint.

(5) Flexural Strength

The flexural strength was measured according to ASTM D-790 by using a specimen (127×12.7×3.2 mm) for the flexural strength by applying a load at a deformation rate of 1 mm/min.

(6) Moist-Heat Durability

A specimen (127×12.7×3.2 mm) of the same type as that described in (5) (a specimen for the flexural strength) was treated in an environment of a temperature of 65° C. and a humidity of 90% RH for 500 hours, and thereafter, the flexural strength was measured by using the method described in (5). This flexural strength is defined as “flexural strength after treatment”. Flexural strength measured at (5) is defined as “flexural strength before treatment”. The strength retention rate in relation to the treated product was calculated by the following formula. The moist-heat durability is preferably 80% or more from the practical viewpoint.

Strength retention rate(%)=(Flexural strength after treatment/flexural strength of untreated product)×100

(7) Flame Retardancy

The flame retardancy was evaluated by performing a combustion test by using a specimen (127×12.7×1.6 mm) for the flame retardancy according to the vertical combustion test method of the United States UL Standard Subject 94 (UL94).

2. Materials

(1) Polylactic Acid Resin

NatureWorks 3001DK (hereinafter abbreviated as “PLA”) manufactured by Cargill Dow LLC, MFR=10 g/10 min, melting point: 168° C.

(2) Crosslinked Polylactic Acid Resin

A double screw extruder (TEM-37BS, manufactured by Toshiba Machine Co., Ltd.) was used, PLA was fed from a top feeder, and melt-kneading extrusion was performed at a processing temperature of 190° C. In this case, a solution prepared by dissolving in 2.5 parts by mass of glycerin diacetomonocaprate that is a plasticizer, 1.0 part by mass of polyethylene glycol dimethacrylate (PEGDM) (manufactured by NOF Corp.) as the crosslinking agent and 1.0 part by mass of di-t-butyl peroxide (manufactured by NOF Corp.) as the crosslinking aid was injected by using a pump from a midway position of the kneader. Then, the discharged resin was cut into a pellet shape, and thus the crosslinked polylactic acid resin (hereinafter abbreviated as “crosslinked PLA”) was obtained. The MFR of the obtained crosslinked PLA was 1.2 g/10 min.

(3) Polycarbonate Resin

200-13 (hereinafter abbreviated as “PC”) manufactured by Sumitomo Dow Ltd., intrinsic viscosity: 0.49

(4) Styrene Thermoplastic Elastomer

Toughtec H1041 (hereinafter abbreviated as “S-TPE-1”) manufactured by Asahi Kasei Chemicals Corp., a hydrogenated styrene-ethylene/butylene-styrene block copolymer

(5) Styrene Thermoplastic Elastomer

Toughtec N503M (hereinafter abbreviated as “S-TPE-2”) manufactured by Asahi Kasei Chemicals Corp., a styrene-butadiene/butylene-styrene block copolymer as a thermoplastic elastomer including a carboxylic acid group introduced thereinto

(6) Styrene Thermoplastic Elastomer

Epofriend CT501 (hereinafter abbreviated as “S-TPE-3”) manufactured by Daicel Chemical Industries, Ltd., a styrene thermoplastic elastomer including an epoxy group introduced thereinto

(7) Ethylene Glycidyl Methacrylate Copolymer with Polymethyl Methacrylate Graft-Copolymerized Therewith (Impact Resistance Improver)

Modiper A4200 (hereinafter abbreviated as “EGMA-gf-PMMA”) manufactured by NOF Corp.

(8) Butadiene Graft Copolymer (Impact Resistance Improver)

Metablen C-223A (hereinafter abbreviated as “M-B”) manufactured by Mitsubishi Rayon Co., Ltd.

(9) Monocarbodiimide Compound

Stabaxol I (hereinafter abbreviated as “M-CD”) manufactured by Rhein Chemie Corp., N,N′-di-2,6-diisopropylphenylcarbodiimide

(10) Polyfunctional Carbodiimide Compound

LA-1 (hereinafter abbreviated as “P-CD-1”) manufactured by Nisshinbo Industries, Inc., with an isocyanate content of 1 to 3%

(11) Polyfunctional Carbodiimide Compound

Stabaxol P (hereinafter abbreviated as “P-CD-2”) manufactured by Rhein Chemie Corp.

(12) Ammonium Polyphosphate

AP422 (hereinafter abbreviated as “FR-1”) manufactured by Clariant (Japan) K.K.

(13) Aromatic Condensed Phosphate

PX-200 (hereinafter abbreviated as “FR-2”) manufactured by Daihachi Chemical Industry Co., Ltd.

(14) Fluororesin

Polyflon PTFE FA-500C (hereinafter abbreviated as “PTFE”) manufactured by Daikin Industries, Ltd., polytetrafluoroethylene

### Examples 1 to 33 and Comparative Examples 1 to 10

In each of Examples 1 to 33 and Comparative Examples 1 to 10, all the materials having the ratios shown in any one of Tables 1 to 3 were uniformly mixed together, then the mixture was fed to the hopper of a double screw extruder (TEM-37BS, manufactured by Toshiba Machine Co., Ltd.) and subjected to a melt-kneading extrusion at a processing temperature of 220 to 240° C., and the resin discharged from a nozzle was cut into a pellet shape to yield a resin composition. It is to be noted that, only in Comparative Example 1, the resin discharged from the nozzle was in a ballast condition, the strands were fragmented and thus no pellet formation was possible.

The obtained resin compositions were subjected to a drying treatment at 80° C. for 5 hours with a hot air dryer, then molded with an injection molding machine (IS-80G manufactured by Toshiba Machine Co., Ltd.), and thus the specimens to be used for the evaluation methods described in (3) to (7) (the evaluation methods for the heat resistance, the impact resistance, the flexural strength, the moist-heat durability and the flame retardancy) were obtained. In this case, each of the resin compositions was melted at the cylinder temperature set at 230 to 210° C., filled in a die set at 60° C. with an injection pressure of 100 MPa and an injection time of 15 seconds, and cooled for 30 seconds.

Various physical properties were evaluated for each of the above-described Examples and Comparative Examples, and the results thus obtained are collectively shown in Tables 1 to 3.

TABLE 1

| | | | Examples | | | | | | | | | |
|---|---|---|---|---|---|---|---|---|---|---|---|---|
| | | | 1 | 2 | 3 | 4 | 5 | 6 | 7 | 8 | 9 | 10 |
| Composition | Polylactic acid resin (A) | PLA | 50 | 70 | 90 | 30 | 25 | 50 | 50 | 50 | 50 | 50 |
| (parts by | | Crosslinked | | | | | | | | | | |
| mass) | | PLA | | | | | | | | | | |
| | Polycarbonate resin (B) | PC | 50 | 30 | 10 | 70 | 75 | 50 | 50 | 50 | 50 | 50 |
| | Styrene thermoplastic | S-TPE-1 | | | | | | 10 | | | | |
| | elastomer (C) | S-TPE-2 | 10 | 10 | 10 | 10 | 10 | | | 1 | 3 | 5 |
| | | S-TPE-3 | | | | | | | 10 | | | |
| | Monocarbodiimide | M-CD | 0.5 | 0.5 | 0.5 | 0.5 | 0.5 | 0.5 | 0.5 | 0.5 | 0.5 | 0.5 |
| | compound (D) | | | | | | | | | | | |
| | Polyfunctional | P-CD-1 | 0.5 | 0.5 | 0.5 | 0.5 | 0.5 | 0.5 | 0.5 | 0.5 | 0.5 | 0.5 |
| | carbodiimide compound | P-CD-2 | | | | | | | | | | |
| | (E) | | | | | | | | | | | |
| | Phosphorus-based flame | FR-1 | | | | | | | | | | |
| | retardant (F) | FR-2 | | | | | | | | | | |
| | Fluororesin | PTFE | | | | | | | | | | |

| | | | | | | | | | | | |
|---|---|---|---|---|---|---|---|---|---|---|---|
| Properties | DTUL(0.45 MPa) (° C.) | 105 | 82 | 71 | 122 | 125 | 106 | 106 | 120 | 117 | 107 |
| | Flexural strength (MPa) | 92 | 99 | 102 | 92 | 90 | 91 | 92 | 111 | 100 | 95 |
| | IZOD impact strength (J/m) | 234 | 173 | 120 | 567 | 621 | 212 | 226 | 76 | 80 | 89 |
| | Moist -heat durability (%) | 100 | 100 | 100 | 100 | 100 | 100 | 100 | 100 | 100 | 100 |
| | Flame retardancy (UL94 1.6 mm) | — | — | — | — | — | — | — | — | — | — |

| | | | Examples | | | | | | | | |
|---|---|---|---|---|---|---|---|---|---|---|---|
| | | | 11 | 12 | 13 | 14 | 15 | 16 | 17 | 18 | 19 |
| Composition | Polylactic acid resin (A) | PLA | 50 | 50 | 50 | 50 | 50 | 50 | 50 | 50 | 50 |
| (parts by | | Crosslinked | | | | | | | | | |
| mass) | | PLA | | | | | | | | | |
| | Polycarbonate resin (B) | PC | 50 | 50 | 50 | 50 | 50 | 50 | 50 | 50 | 50 |
| | Styrene thermoplastic | S-TPE-1 | | | | | | | | | |
| | elastomer (C) | S-TPE-2 | 15 | 20 | 30 | 10 | 10 | 10 | 10 | 10 | 10 |
| | | S-TPE-3 | | | | | | | | | |
| | Monocarbodiimide | M-CD | 0.5 | 0.5 | 0.5 | 0.5 | 0.05 | 0.25 | 1 | 2.5 | 3 |
| | compound (D) | | | | | | | | | | |
| | Polyfunctional | P-CD-1 | 0.5 | 0.5 | 0.5 | | 0.05 | 0.25 | 1 | 2.5 | 3 |
| | carbodiimide compound | P-CD-2 | | | | 0.5 | | | | | |
| | (E) | | | | | | | | | | |
| | Phosphorus-based flame | FR-1 | | | | | | | | | |
| | retardant (F) | FR-2 | | | | | | | | | |
| | Fluororesin | PTFE | | | | | | | | | |

| | | | | | | | | | | |
|---|---|---|---|---|---|---|---|---|---|---|
| Properties | DTUL(0.45 MPa) (° C.) | 102 | 95 | 79 | 105 | 101 | 103 | 100 | 95 | 85 |
| | Flexural strength (MPa) | 85 | 79 | 67 | 92 | 91 | 91 | 91 | 89 | 80 |
| | IZOD impact strength (J/m) | 298 | 340 | 421 | 254 | 216 | 220 | 212 | 198 | 163 |
| | Moist -heat durability (%) | 100 | 100 | 100 | 100 | 89 | 100 | 100 | 100 | 100 |
| | Flame retardancy (UL94 1.6 mm) | — | — | — | — | — | — | — | — | — |

TABLE 2

| | | | Examples | | | | | | | | | | | | | |
|---|---|---|---|---|---|---|---|---|---|---|---|---|---|---|---|---|
| | | | 20 | 21 | 22 | 23 | 24 | 25 | 26 | 27 | 28 | 29 | 30 | 31 | 32 | 33 |
| Compo- | Polylactic acid | PLA | 50 | 50 | 50 | 50 | 50 | 50 | | 50 | 50 | 50 | 50 | 50 | 50 | 50 |
| sition | resin (A) | Crosslinked | | | | | | | 50 | | | | | | | |
| (parts | | PLA | | | | | | | | | | | | | | |
| by | Polycarbonate | PC | 50 | 50 | 50 | 50 | 50 | 50 | 50 | 50 | 50 | 50 | 50 | 50 | 50 | 50 |
| mass) | resin (B) | | | | | | | | | | | | | | | |
| | Styrene | S-TPE-1 | | | | | | | | | | | | | | |
| | thermoplastic | S-TPE-2 | 10 | 10 | 10 | 10 | 10 | 10 | 10 | 10 | 10 | 10 | 10 | 10 | 10 | 10 |
| | elastomer (C) | S-TPE-3 | | | | | | | | | | | | | | |
| | Monocarbodiimide | M-CD | 0.05 | 0.1 | 0.3 | 0.7 | 0.9 | 0.95 | 0.5 | 0.5 | 0.5 | 0.5 | 0.5 | 0.5 | 0.5 | 0.5 |
| | compound (D) | | | | | | | | | | | | | | | |
| | Polyfunctional | P-CD-1 | 0.95 | 0.9 | 0.7 | 0.3 | 0.1 | 0.05 | 0.5 | 0.5 | 0.5 | 0.5 | 0.5 | 0.5 | 0.5 | 0.5 |
| | carbodiimide | P-CD-2 | | | | | | | | | | | | | | |
| | compound (E) | | | | | | | | | | | | | | | |
| | Phosphorus-based | FR-1 | | | | | | | | 10 | | 5 | 20 | | 10 | 30 |
| | flame | | | | | | | | | | | | | | | |
| | retardant (F) | FR-2 | | | | | | | | | 10 | 5 | | 20 | 10 | |
| | Fluororesin | PTFE | | | | | | | | | | | 0.2 | 0.2 | 0.2 | 0.2 |

| | | | | | | | | | | | | | | | |
|---|---|---|---|---|---|---|---|---|---|---|---|---|---|---|---|
| Proper- | DTUL(0.45 MPa) (° C.) | 111 | 109 | 108 | 107 | 106 | 104 | 110 | 102 | 98 | 101 | 101 | 97 | 102 | 100 |
| ties | Flexural strength (MPa) | 93 | 93 | 93 | 92 | 89 | 85 | 95 | 85 | 89 | 87 | 80 | 85 | 83 | 80 |
| | IZOD impact strength (J/m) | 199 | 203 | 220 | 230 | 235 | 239 | 382 | 95 | 104 | 97 | 73 | 79 | 75 | 56 |
| | Moist-heat durability (%) | 86 | 95 | 100 | 100 | 98 | 76 | 100 | 100 | 100 | 100 | 89 | 97 | 95 | 83 |
| | Flame retardancy (UL94 1.6 mm) | — | — | — | — | — | — | — | V-2 | V-2 | V-2 | V-1 | V-1 | V-1 | V-0 |

TABLE 3

| | | | Comparative Examples | | | | | | | | | |
|---|---|---|---|---|---|---|---|---|---|---|---|---|
| | | | 1 | 2 | 3 | 4 | 5 | 6 | 7 | 8 | 9 | 10 |
| Composition | Polylactic acid resin (A) | PLA | 50 | 50 | 50 | 50 | 50 | 50 | 50 | 95 | 95 | 50 |
| (parts by | | Crosslinked | | | | | | | | | | |
| mass) | | PLA | | | | | | | | | | |
| | Polycarbonate resin (B) | PC | 50 | 50 | 50 | 50 | 50 | 50 | 50 | 5 | 5 | 50 |
| | Styrene thermoplastic | S-TPE-1 | | | | | | | | | | |
| | elastomer (C) | S-TPE-2 | | | 10 | 10 | 10 | | | 10 | 10 | |
| | | S-TPE-3 | | | | | | | | | | |
| | Impact resistance | EGMA-gf- | | | | | | | 10 | | | |
| | improvers other than (C) | PMMA | | | | | | | | | | |
| | | M-B | | | | | | 10 | | | | |
| | Monocarbodiimide | M-CD | | 0.5 | | 1 | | 0.5 | 0.5 | 0.5 | 0.5 | 0.5 |
| | compound (D) | | | | | | | | | | | |
| | Polyfunctional | P-CD-1 | | 0.5 | | | 1 | 0.5 | 0.5 | 0.5 | 0.5 | 0.5 |
| | carbodiimide compound | P-CD-2 | | | | | | | | | | |
| | (E) | | | | | | | | | | | |
| | Phosphorus-based flame | FR-1 | | | | 10 | 10 | 10 | 10 | | 10 | 10 |
| | retardant (F) | FR-2 | | | | | | | | | | |
| | Fluororesin | PTFE | | | | | | | | | | |

| | | | | | | | | | | | |
|---|---|---|---|---|---|---|---|---|---|---|---|
| Properties | DTUL(0.45 MPa) (° C.) | — | 121 | 105 | 102 | 100 | 101 | 102 | 67 | 60 | 116 |
| | Flexural strength (MPa) | — | 112 | 95 | 87 | 86 | 86 | 85 | 105 | 101 | 109 |
| | IZOD impact strength (J/m) | — | 42 | 214 | 97 | 75 | 70 | 62 | 95 | 34 | 27 |
| | Moist-heat durability (%) | — | 100 | 26 | 45 | 52 | 70 | 78 | 100 | 66 | 74 |
| | Flame retardancy (UL94 1.6 mm) | — | — | — | V-2 | V-2 | V-2 | V-2 | — | V-2 | V-2 |

In each of Examples 1 to 33, satisfactory numerical values were obtained for all the DTUL, Izod impact strength and moist-heat durability. In each of Examples 27 to 33 where one or more flame retardants were further mixed, any one of the UL flame retardancy standards V-2 to V-0 was obtained. In Examples 26, a crosslinked polylactic acid was used as the polylactic acid, and hence the Izod impact strength and the DTUL were found to be improved as compared to Example 1 where the conditions other than the use of the crosslinked polylactic acid were the same. In each of Examples 30 to 33, a fluororesin was added in addition to the flame retardant, and hence the fall (dripping) of the combusted matter was suppressed so as to attain the flame retardancy of any one of V-0 to V-1.

On the other hand, in Comparative Example 1, only PLA and PC were used, hence PLA and PC were not satisfactorily mixed with each other at the time of melt-kneading extrusion, and thus, no strands were able to be drawn. In each of Comparative Examples 2 and 10, no styrene thermoplastic elastomer was included, and hence the Izod impact strength was low. In each of Comparative Examples 3 to 5, the monocarbodiimide compound and the polyfunctional carbodiimide compound were not used in combination, and hence the moist-heat durability was lower than Examples 1 and 27 in which the monocarbodiimide compound and the polyfunctional carbodiimide compound were used in combination and the other conditions were the same as the corresponding conditions in Comparative Examples 3 to 5. In each of Comparative Examples 6 and 7, an impact resistance improver other than the styrene thermoplastic elastomer was used, and hence the moist-heat durability was inferior to the moist-heat durability of Example 1 in which the styrene thermoplastic elastomer was used and the other conditions were the same as the corresponding conditions in Comparative Examples 6 and 7. In each of Comparative Examples 8 and 9, the ratio of PLA to PC was too high, and hence the DTUL, Izod impact strength and moist-heat durability were lower than the corresponding values in Examples 1 to 5 and 27 in which the concerned ratio was appropriate and the other conditions were the same as the corresponding conditions in Comparative Examples 8 and 9.

1. A resin composition comprising a polylactic acid resin (A), a polycarbonate resin (B), a styrene thermoplastic elastomer (C), a monocarbodiimide compound (D) and a polyfunctional carbodiimide compound (E), wherein a mass ratio (A/B) between the polylactic acid resin (A) and the polycarbonate resin (B) is 25/75 to 90/10.

2. The resin composition according to claim 1, wherein an amount of the styrene thermoplastic elastomer (C) is 3 to 20 parts by mass in relation to 100 parts by mass of a total amount of the polylactic acid resin (A) and the polycarbonate resin (B), a total amount of a the monocarbodiimide compound (D) and the polyfunctional carbodiimide compound (E) is 0.5 to 5 parts by mass in relation to 100 parts by mass of the total amount of the polylactic acid resin (A) and the polycarbonate resin (B), and a mass ratio (D/E) between the monocarbodiimide compound (D) and the polyfunctional carbodiimide compound (E) is 10/90 to 90/10.

3. The resin composition according to claim 1, wherein the styrene thermoplastic elastomer (C) is of a hydrogenated type.

4. The resin composition according to claim 1, wherein the styrene thermoplastic elastomer (C) has a functional group.

5. The resin composition according to claim 1, further comprising a phosphorus-based flame retardant (F).

6. The resin composition according to claim 1, wherein the polylactic acid resin (A) is a crosslinked polylactic acid resin.

7. A molded body obtained by molding the resin composition according to claim 1.

8. A molded body obtained by molding the resin composition according to claim 2.

9. A molded body obtained by molding the resin composition according to claim 3.

10. A molded body obtained by molding the resin composition according to claim 4.

11. A molded body obtained by molding the resin composition according to claim 5.

12. A molded body obtained by molding the resin composition according to claim 6.
